(19) United States
(12) Patent Application Publication
(10) Pub. No.: US 2024/0065467 A1
(43) Pub. Date: Feb. 29, 2024

(54) KETTLE AND UNIBODY HANDLE WITH INTEGRATED SPOUT AND EXCHANGEABLE WHISTLE ELEMENT

(71) Applicant: Caraway Home, Inc., New York, NY (US)

(72) Inventors: Jordan Nathan, New York, NY (US); Bret Recor, San Francisco, CA (US); Kenneth Young, San Francisco, CA (US); Benjamin Gross, San Francisco, CA (US); Christoph Andrejcic, San Francisco, CA (US)

(73) Assignee: Caraway Home, Inc., New York, NY (US)

(21) Appl. No.: 18/237,389

(22) Filed: Aug. 23, 2023

Related U.S. Application Data
(60) Provisional application No. 63/400,376, filed on Aug. 23, 2022.

(51) Int. Cl. A47J 27/21; A47J 27/212; A47J 45/06

(52) U.S. Cl. CPC A47J 27/21191; A47J 27/21175; A47J 27/212; A47J 45/065

(57) ABSTRACT

A kettle comprising, a body having a vent; a lid reversibly couplable to the body; and a unibody handle comprising, a distal end, a proximal end disposed on the body, an integrated lever comprising, at least one interchangeable whistle disposed on a lever proximal end, wherein the at least one interchangeable whistle reversibly attaches to the integrated lever, wherein the at least one interchangeable whistle is configured to be in at least one of a seated position and a raised position, a tab disposed on a lever distal end, wherein actuation of the tab causes the at least one interchangeable whistle to move from at least one of the seated position to the raised position and the raised position to the seated position, and a spout disposed on the proximal end, wherein the spout entirely eclipses the vent wherein the spout entirely eclipses the vent.

### FIELD OF INVENTION

The invention is in the field of kitchen devices, specifically, kettles comprising unibody handle-spout-integration and/or interchangeable whistle features.

### INTRODUCTION

For many individuals, the morning is typically accompanied by a hot beverage of some sort, whether it be coffee or tea. Both of these beverages require the use of boiling water. Kettles have risen in popularity due to their various features. This includes their spout aimed at avoiding spillage, a feature of great importance when it comes to boiling liquid, their handle to aid in function, and their whistle to alert the user when water is boiling. To streamline the morning routine, kettles have found their permanent nesting place on the stove. This way, a user may ignite the stove and wait for the kettle to alert once water has boiled. It becomes especially important that the user can clearly hear the kettle's sounding whistle. Further, because kettles are typically stored on the stove, it becomes especially important that they are compact so that they do not take up too much space and prevent the use of adjacent stove burners.

Conventional kettles aim to simplify the pouring process by including a lever wherein the user may press it and the spout may open, allowing the user to pour the liquid into their cup. Further, the spout may include a small hole, which when the spout is closed, may cause the kettle to whistle, alerting the user that the water is boiling. However, conventional handles are often wide and cumbersome as to support external lever mechanics. This creates a bulky design which produces space wasting issues for the user. With an increasing number of appliances and cookware items in the average kitchen, space-saving varieties of such objects have become a priority. Further, different users may benefit from a variety of kitchen whistles depending on the user's hearing or the distance the whistle needs to be heard from. Hearing the whistle becomes an utmost priority on a busy morning when there is boiling water on the stove and a user may forget the kettle is on the lit stovetop.

Therefore, it would be desirable to provide a kettle wherein the handle and spout are a unibody piece such that a more streamlined lever process is achieved, thus cutting down on a bulky design which may waste space. A user may be more motivated to store their kettle on the stove top, thus supporting a more streamlined morning routine. Further, it would be desirable to provide a kettle where the user may choose the whistle pitch that aligns with their desired kettle uses. This may be achieved with interchangeable whistles wherein the user with a larger space may select a nozzle creating a higher pitched whistle and the user with a sensitivity to sound may select a nozzle creating a lower pitched whistle. Therefore, a kettle providing such features is desirable.

### SUMMARY

This Summary is provided to introduce a selection of concepts in a simplified form that are further described below in the Detailed Description. This Summary is not intended to identify key features or essential features, nor is it intended to limit the scope of the claims included herewith.

In an aspect, a kettle comprising: a body having a vent; a lid reversibly connectable to the body; and a unibody handle comprising, a distal end, a proximal end disposed on the body, an integrated lever comprising, at least one interchangeable whistle disposed on a lever proximal end, wherein the at least one interchangeable whistle reversibly attaches to the integrated lever, wherein the at least one interchangeable whistle is configured to be in at least one of a seated position and a raised position, a tab disposed on a lever distal end, wherein actuation of the tab causes the at least one interchangeable whistle to move from at least one of the seated position to the raised position and the raised position to the seated position, and a spout disposed on the proximal end, wherein the spout entirely eclipses the vent.

In an embodiment, the body further comprises: a baseplate; a brim; and a sidewall, having a sidewall top portion and a sidewall bottom portion, disposed between the brim and the baseplate. In a further embodiment, the sidewall bottom portion is of a greater thickness than the sidewall top portion, such that the difference in thickness induces convection heating of a kettle contents. In yet a further embodiment, the baseplate further comprises: a bevel, wherein the bevel increases a baseplate surface area, such that the increase in surface area improves heating of the kettle contents.

In an alternate embodiment, the kettle further comprises: a mount disposed atop the lid; and a partially hollow grip configured to attach to the mount. In another embodiment, the mount and the partially hollow grip are configured to threadably attach.

In one embodiment, the lid is comprised of a lid top piece and a lid bottom piece, wherein the lid top piece and the lid bottom piece form an air gap configured to reduce heat transfer between the lid bottom piece and the lid top piece.

In an embodiment, the distal end and the proximal end are recessed. In a further embodiment, the distal end is disposed on the body. In yet a further embodiment, the kettle further comprises, a bridge disposed between the distal end and the proximal end.

In another embodiment, the kettle further comprises a gap disposed at the proximal end, wherein the integrated lever is configured to be received by the gap. In an embodiment, the kettle further comprises an indexing hole disposed at the proximal end. In a further embodiment, the kettle further comprises a lever pivot hole disposed upon the integrated lever. In yet a further embodiment, the kettle further comprises a fastening pin configured to be inserted through both the indexing hole and the lever pivot hole to secure the integrated lever to the unibody handle.

In an embodiment, the kettle further comprises a receiver aperture disposed at the lever proximal end, wherein the receiver aperture is configured to accept the at least one interchangeable whistle. In another embodiment, the receiver aperture and the at least one interchangeable whistle threadably engage. In one embodiment, the at least one interchangeable whistle further comprises a whistle bore, wherein the whistle bore is hollow and is adapted to induce an auditory tone. In a further embodiment, the at least one interchangeable whistle further comprises a whistle top opening, having a top opening diameter, and a whistle bottom opening, having a bottom opening diameter. In yet a further embodiment, the top opening diameter and the bottom opening diameter are not equal.

Provided may be a kettle comprising: a body comprising, a vent, a brim, a baseplate, and a sidewall, having a sidewall top portion and a sidewall bottom portion, disposed between the brim and the baseplate, wherein the sidewall bottom portion has a thickness greater than the sidewall top portion; a lid reversibly couplable to the body, the lid comprising, a mount, a partially hollow grip, wherein the mount and the partially hollow grip threadably attach; and a unibody handle comprising, a recessed distal end disposed on the body, a recessed proximal end disposed on the body, an integrated lever comprising, a receiver aperture disposed on a lever proximal end, at least one interchangeable whistle disposed on the lever proximal end, wherein the receiver aperture and the at least one interchangeable whistle threadbly attach, wherein the at least one interchangeable whistle is configured to be in at least one of a seated position and a raised position, a tab disposed on a lever distal end, wherein actuation of the tab causes the at least one interchangeable whistle to move from at least one of the seated position to the raised position and the raised position to the seated position, and a spout disposed on the recessed proximal end, wherein the spout entirely eclipses the vent.

These and other aspects, features, and advantages of the present invention will become more readily apparent from the following drawings and the detailed description of the preferred embodiments.

PARTS LIST

| | |
|---|---|
| 100 | Kettle |
| 102 | Body |
| 104 | Lid |
| 106 | Grip |
| 108 | Handle |
| 110 | Handle Proximal End |
| 112 | Handle Distal End |
| 114 | Handle Inner Surface |
| 116 | Handle Outer Surface |
| 118 | Lever |
| 120 | Whistle |
| 122 | Tab |
| 124 | Sidewall |
| 126 | Brim |
| 128 | Base Plate |
| 130 | Main Aperture |
| 132 | Cavity |
| 134 | Vent |
| 136 | Gap |
| 138 | Bevel |
| 140 | Baseplate Plane |
| 142 | Indexing Hole |
| 144 | Lid Rim |
| 146 | Lid Well |
| 148 | Lid Neck |
| 150 | Divot |
| 152 | Lid Sub-Body |
| 154 | Gasket |
| 156 | Prox. Attachment Point |
| 158 | Distal Attachment Point |
| 160 | Proximal Post |
| 162 | Distal Post |
| 164 | Bridge |
| 166 | Spout |
| 168 | Whistle Top Portion |
| 170 | Whistle Stem |
| 172 | Whistle Thread |
| 174 | Whistle Bore |
| 176 | Lever Pivot Hole |
| 178 | Receiver Aperture |
| 180 | Link |
| 182 | Lever Proximal End |
| 184 | Lever Distal End |
| 186 | Ledge |
| 188 | Nodule |
| 190 | Spout Gasket |
| 192 | Top Whistle Opening |
| 194 | Bottom Whistle Opening |

### BRIEF DESCRIPTION OF THE DRAWINGS

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1 is a perspective view of an embodiment of a kettle comprising a whistle in the seated state.

FIG. 2 is a perspective view of an embodiment of a kettle comprising a whistle in the raised state.

FIG. 3 is a perspective view of an embodiment of a kettle body.

FIG. 4 is a front view of an embodiment of a kettle.

FIG. 5 is a side view of an embodiment of a kettle.

FIG. 6 is a top view of an embodiment of a kettle.

FIG. 7 is a bottom view of an embodiment of a kettle.

FIG. 8 is a perspective view of an embodiment of a kettle lid.

FIG. 9 is a side view of an embodiment of a kettle lid.

FIG. 10 is a bottom view of an embodiment of a kettle lid.

FIG. 11 is a sectional view of an embodiment of a kettle lid.

FIG. 12 is a perspective view of an embodiment of a kettle handle.

FIG. 13 is a front view of an embodiment of a kettle handle.

FIG. 14 is a rear view of an embodiment of a kettle handle.

FIG. 15 is a side view of an embodiment of a kettle handle.

FIG. 16 is a side view of an embodiment of a kettle handle.

FIG. 17 is a perspective view of an embodiment of a kettle whistle.

FIGS. 18-19 are a perspective view of an embodiment of a kettle lever.

FIG. 20 is a side view of an embodiment of a kettle lever.

FIGS. 21-24 are illustrations of an embodiment of a kettle whistle.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that the description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

Aspects of the present disclosure may include a kettle comprising a unibody handle, wherein the handle may comprise a detachable whistle and an integrated spout. Specifically, the handle may be formed as a unibody member such that the integrated spout may interface with a vent of the kettle body. Accordingly, the entire handle assembly may be simply affixed to the kettle body, enabling whistle functionality, spout utilization, and a compact lever integration. In effect, the kettle may be comprised of two main components: the kettle body, and the handle assembly. However, in an embodiment, the handle is permanently fixed to the body and the lever is not easily separable from the handle.

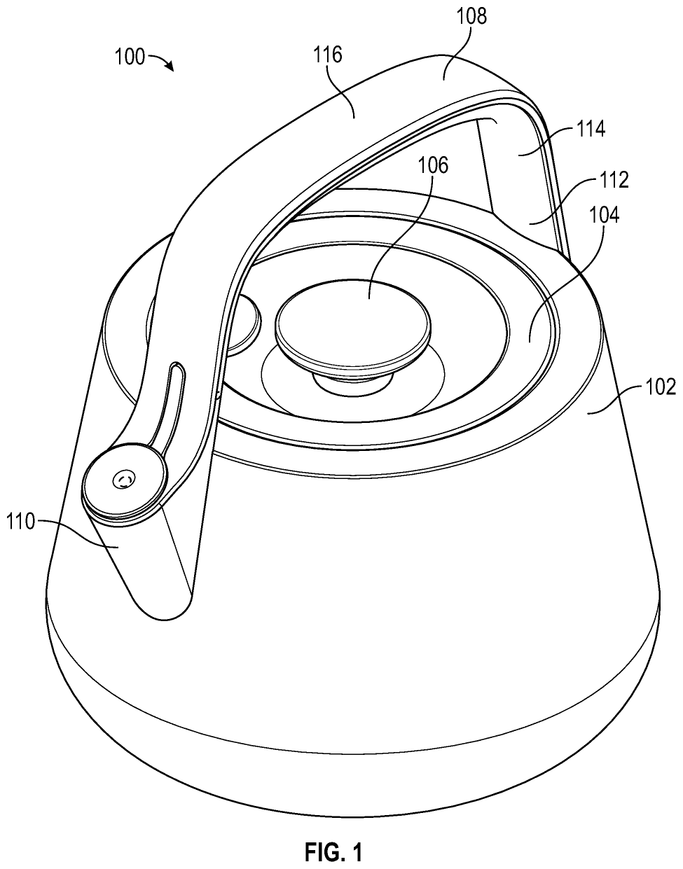

Referring to FIG. 1, the kettle 100 comprises a body 102, a lid 104, a grip 106, and/or a handle 108. The body 102 may be a hollow member configured to retain a fluid. In an embodiment, the body 102 is reversibly couplable with a lid 104. The body 102 may be sized to accept the lid 104 atop the body 102. However, in alternate embodiments the lid 104 may be configured to attach with any suitable portion of the body 102. The lid 104 may comprise a grip 106, wherein the grip 106 may be disposed atop the lid 104. Further, the grip 106 may be disposed central to the lid 104 and may extend orthogonally from the top surface of the lid 104. Accordingly, a user may grasp the grip 106 and apply a pulling force to remove the lid 104 from the body 102.

The handle 108 may be a unibody member attached to the body 102. In an alternative embodiment, the handle 108 may not be a unibody member attached to the body 102. In such an embodiment, the handle 108 may not be comprised of an integrated spout, wherein the handle 108 and the spout are separate components individually attached to the body 102. In one alternative embodiment, the handle 108 may include the appearance of a unibody member, while being comprised of two or more components (e.g., to halves pressed to form one). The handle 108 may be disposed on the body 102 such that the handle 108 extends over the top surface of the body 102. The handle 108 may include a handle proximal end 110 and a handle distal end 112. The handle proximal end 110 may be disposed on the portion of the body 102 wherein gas and/or liquid may exit the body 102. For example, the expulsion of gas during boiling and/or flow of liquid during pouring may occur at the handle proximal end 110. The handle distal end 112 may be disposed opposite of the handle proximal end 110. However, in alternate embodiments, the handle proximal end 110 and the handle distal end 112 may be disposed in any positions that enable a user to support the kettle 100 by the handle 108. Further, the handle 108 may include a handle inner surface 114 and a handle outer surface 116. The handle inner surface 114 may face toward the body 102. Accordingly, one or more portions of the handle inner surface 114 may be configured to interface with the body 102 to facilitate attachment of the handle 108 with the body 102.

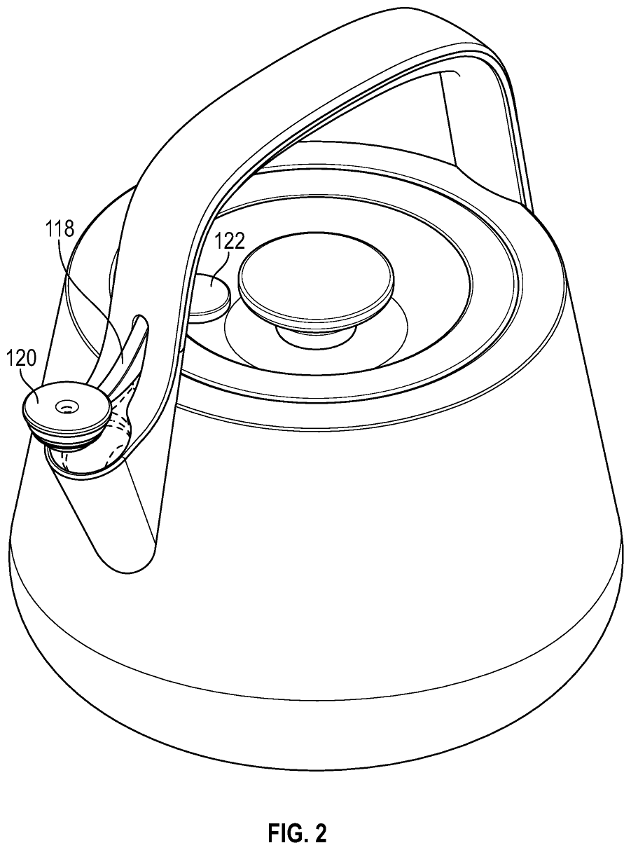

Referring to FIG. 2, the handle 108 may include an integrated lever 118. The lever 118 may comprise a whistle 120 and a tab 122. The whistle 120 may be configured to receive gas from the inside of the body 102 and expel said gas to the environment. Accordingly, during the transport of gas through the whistle 120, the whistle 120 may emanate an audible tone. For example, the whistle 120 may generate a noise of a predetermined pitch. Thus, the whistle 120 may be sized to produce a desired pitch (or other audio characteristic).

The tab 122 may be positioned on the lever 118, opposite the whistle 120, such that actuation of the tab 122 causes the whistle 120 to temporarily lift. Thus, the whistle 120 may occupy a seated position or a raised position. In a seated position, the whistle 120 may form a seal with the handle 108, channeling gas from the inside of the body 102 to the environment. Said channeling of gas, achieved by the seal formed from the whistle 120 and the handle 108, may provide a user with a predictable path the gas follows, to ensure said user does not burn themselves. In a raised position, the whistle 120 may uncouple from the handle 108, allowing uninterrupted fluid transmission between the body 102 and the environment.

The lever 118 may be shaped such that, in the seated position, the curvature of the lever 118 mimics that of the handle 108. Further, the curvature of the lever 118 may be configured to minimize sharp edges and/or touchpoints. As shown in FIG. 1, the curvature of the lever 118, in the seated position, and the handle 108 may produce a ‘continuous’ appearance. By importing the curvature of the handle 108 to the lever 118, the handle/lever 108/118 combination may be less obtrusive to the user. As a non-limiting example, a conventional kettle having a lever that may jut from the stem or spout of the kettle may increase potential or snags or inadvertent actuation. Accordingly, such conventional kettles lacking the ‘continuous’ curvature as represented in the lever 118 of FIGS. 1 and 2 may increase risk of injury when handling boiling liquids above, for example, an open flame. The lever 118 of the FIGS. 1 and 2 may also provide a means of apparent indexing with the handle 108. For example, because the outward facing surface of the lever 118 is flush with the handle 108 in the seated position, it is visually and tactilely clear when the lever 118 is not seated.

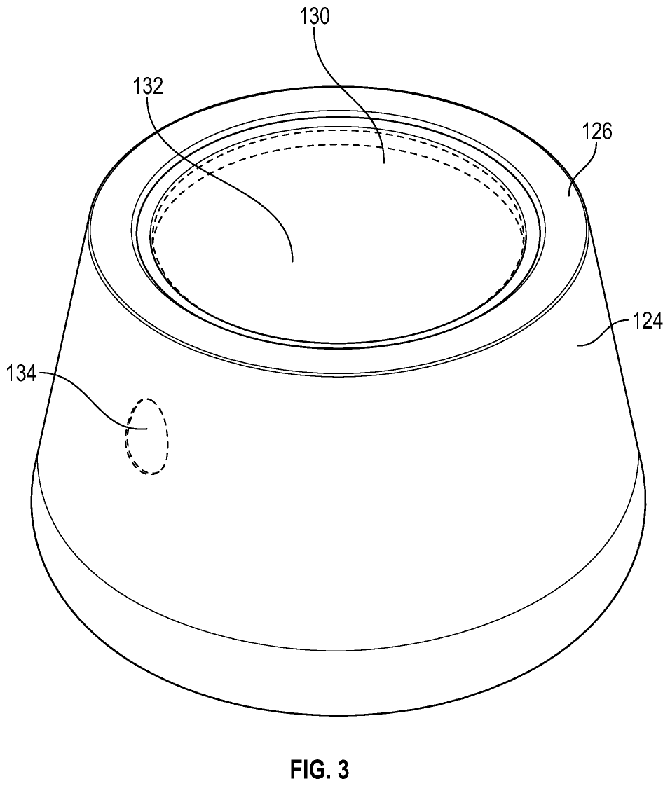

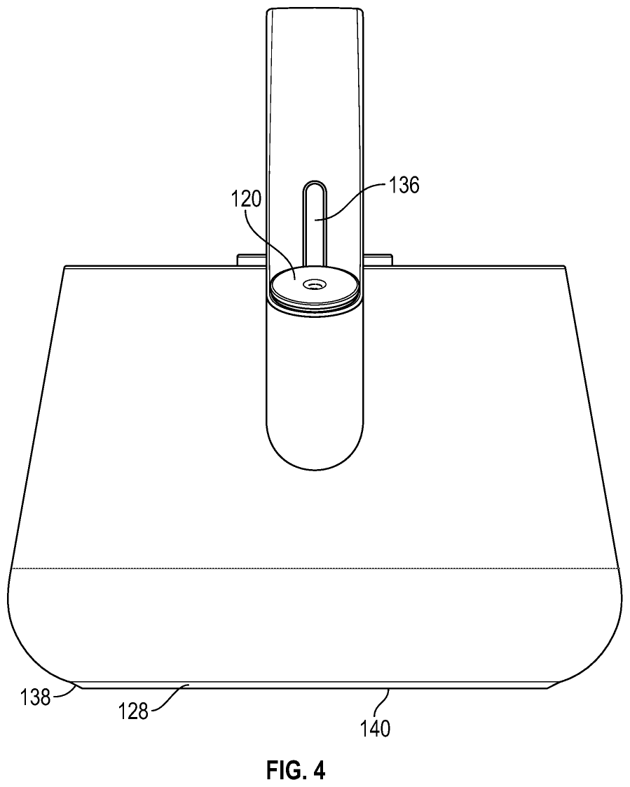

Referring to FIGS. 3 and 4, the body 102 may include a sidewall 124, a brim 126, and/or a baseplate 128. The sidewall 124 may be formed of a continuous sheet and may form the majority of the body 102. In one embodiment, the sidewall 124 may include a universal thickness. However, in alternate embodiments, the sidewall 124 may differ in thickness according to the positioning of a particular portion of sidewall 124. As a non-limiting example, the sidewall 124 may be of greater thickness on the bottom portion of the body 102 as to induce convection heating of the contents of the kettle 100. In one embodiment, the sidewall 124 is formed from a single piece of metal that is hydro-formed. In an embodiment, the sidewall 124 and/or other components of the body 102 may be of uniform thickness. However, in alternate embodiments the thickness of the sidewall 124 and/or other components of the body 102 may fluctuate along various portions of the body 102.

The sidewall 124 may extend from the brim 126 to the baseplate 128. In an embodiment, the baseplate 128 is disposed on the bottom of the body 102, yet in complete contact with the sidewall 124. Alternatively, the baseplate 128 may be disposed on the bottom of the body 102, yet may be in contact with the sidewall 124 only at the outermost perimeter of the baseplate 128. The baseplate 128 may be configured to allow heat transfer between the heat source and the content of the body 102. Further, the baseplate 128 may promote stability in the body 102. For example, the base plate 128 may be sufficiently flat and of a suitable surface area to create a sturdy contact with the receiving surface. The stability of the baseplate 128 may provide the user with insurance that the kettle 100 will not tip and spill its contents. The brim 126 may be disposed non-parallel to the sidewall 124. Accordingly, the brim 126 may be an annular member having a flat surface. In an embodiment, one or more components (e.g., the sidewall 124 and/or the brim 126) may include a concave, convex, or otherwise dished surface to promote the capture of water droplets that would otherwise form around the inside surface of the body during removal of the lid 104 or when initially filling the body 102.

In an embodiment, a main aperture 130 may be bound by the brim 126. The main aperture 130 may be a void in the top surface of the body 102 adapted to allow fluid communication between the environment and the cavity 132 of the body 102. The cavity 132 may be a central hollow portion of the body 102, wherein the cavity 132 is bound by at least the sidewall 124. Moreover, the cavity 132 may be bound by the baseplate 128 and the sidewall 124. In yet a further embodiment, the cavity 132 is bound by the baseplate 128, the sidewall 124, the brim 126, and/or the lid 104.

Further, the body 102 may include a vent 134 disposed on the sidewall 124. The vent 134 may allow for fluid communication between the cavity 132 and the environment. The facilitation of fluid communication between the cavity 132 and the environment by the vent 134, may prevent an increase in internal pressure of the body 102. Accordingly, the vent 134 may be sized and configured to direct gas through the whistle 120 and/or liquid through the handle proximal end 110. In such an embodiment, the vent 134 may be entirely eclipsed by the handle proximal end 110 such that a seal is formed between the vent 134 and the handle proximal end 110. The vent 134 may be sized complementary to the spout 166. For example, the vent 134 and the spout 166 may be sized such that the handle 108, spout 166, and/or body 102 may be affixed via a laser welding process. In one embodiment, the spout 166 and/or vent 134 may include a filter and/or a means of attaching a filter. However, in another embodiment, the kettle 100 does not include a filter.

Referring to FIG. 4, the baseplate 128 may include a bevel 138 and a baseplate plane 140. The baseplate plane 140 may be a planar surface bound by the bevel 138, wherein the bevel 138 may be an annular member in contact with the body 102 and the baseplate plane 140. In one embodiment, as shown in FIG. 4, the bevel 138 may be tapered such that the bevel 138 forms a roughly forty-five-degree ramp between the baseplate plane 140 and the body 102. The tapered bevel 138 may allow for greater baseplate 128 contact with the body 102, allowing for the heat source to more effectively heat the contents of the body 102. The baseplate plane 140 may be sized such that the kettle 100 is stovetop agnostic (e.g., compatible with induction, gas, and electric stovetops).

The handle 108 may include a gap 136 disposed at the handle proximal end 110, wherein the gap 136 is sized to allow captured containment of the lever 118. The gap 136 may include a perimeter having a curvature adapted to create a ‘seamless’ appearance across the handle 108 and the lever 118. The gap may be sized to allow captured containment of one or more levers 118 that may allow a user to interchange the one or more levers 118.

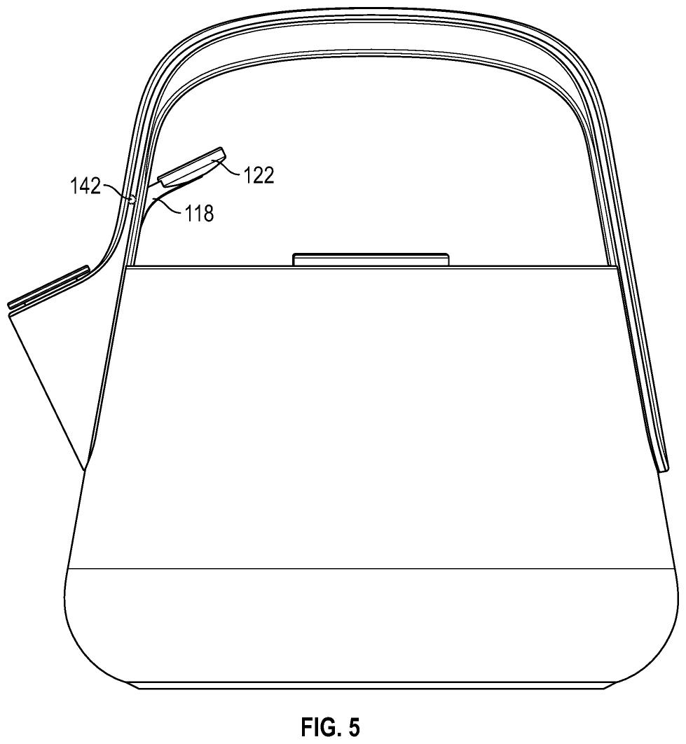

Referring to FIG. 5, the handle 108 may include an indexing hole 142 configured to accept a retainer and/or pin. The indexing hole 142 may allow for the lever 118 to be mounted to the handle 108, for example, through the gap 136. In an embodiment, the lever 118 may be coupled to the handle 108 via a pin, wherein the pin is shaped to create a definitive stopping point for the start and end position of the lever 118 rotation. Such a pin may be maintained within the indexing hole 142 via press fit. Said pin may removably engage with the indexing hole 142, wherein the user may easily remove and/or insert the pin from and/or into the indexing hole 142.

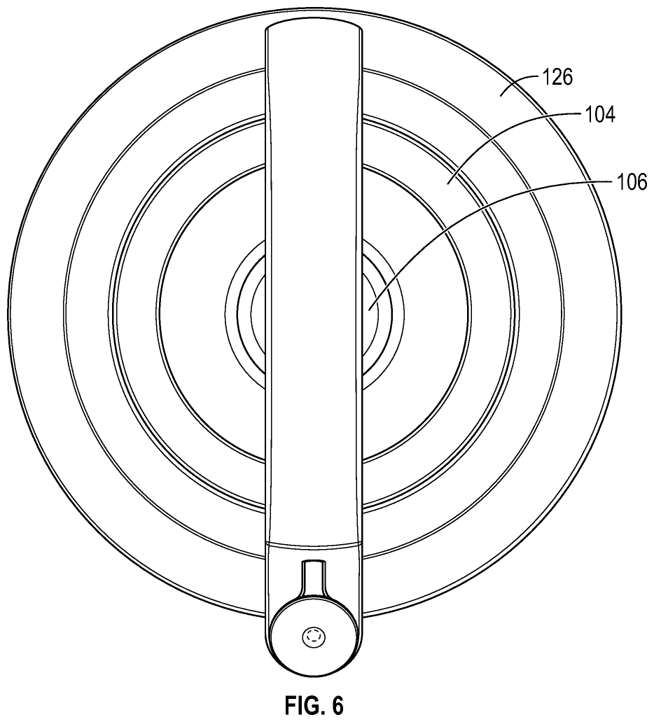

Referring to FIG. 6, the lid 104 may be disposed central to the top surface of the body 102. However, in alternate embodiments, the lid 104 may be disposed along any suitable area of the top surface of the body 102.

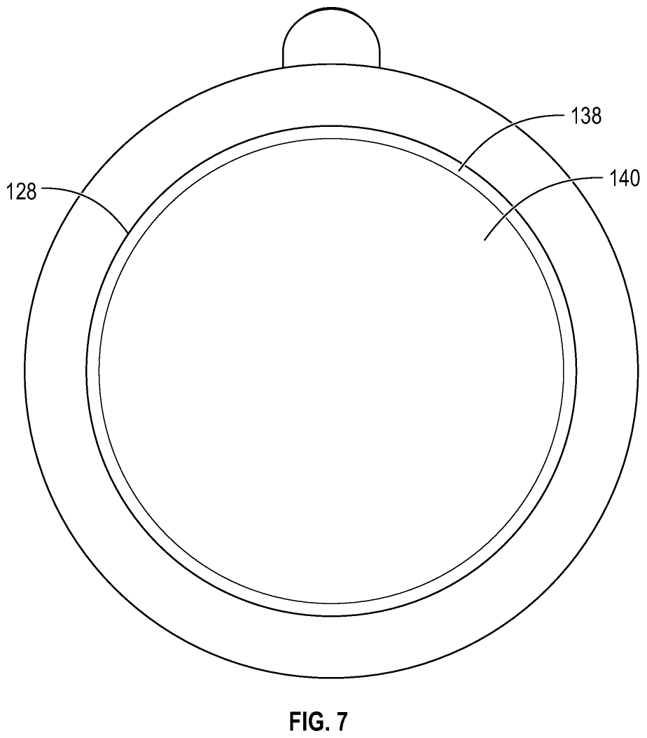

Referring to FIG. 7, the base plate 128 may be disposed central to the bottom portion of the body 102. For example, the base plate 128 may be circular, wherein the bevel 138 is an annular member circumferentially surrounding the baseplate plane 140. In an embodiment, the central disposition of the base plate 128 to the bottom portion of the body 102 stabilizes the kettle 100, such that the kettle 100 does not tip.

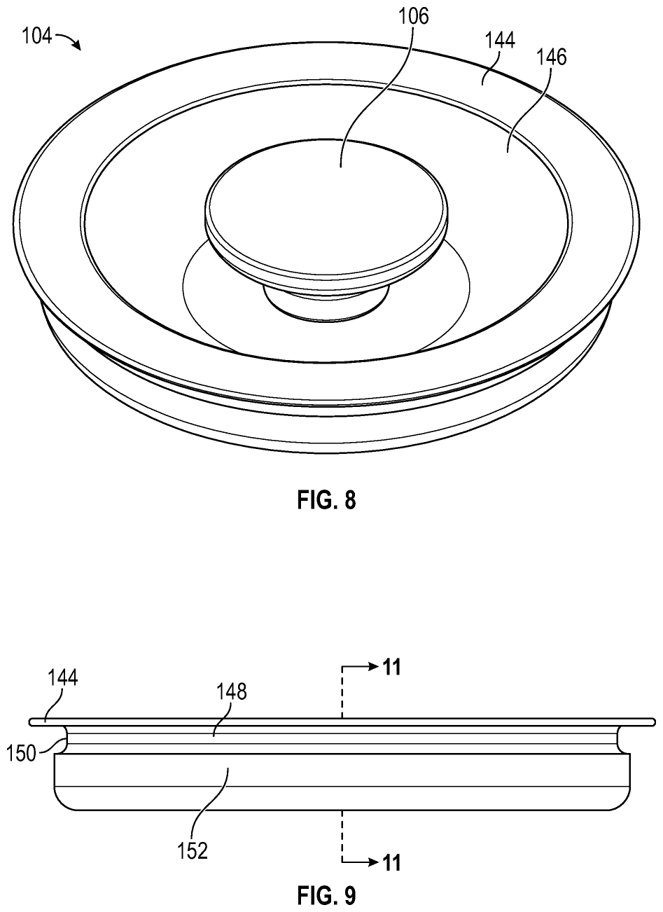

Referring to FIG. 8, the lid 104 may include a grip 106, a lid rim 144, and/or a lid well 146. The grip 106 may include an upper portion having a greater surface area than the lower portion. For example, the grip 106 may be sized such that the stem of the grip 106 may support the upper portion of the grip 106. Further, the stem may be of a smaller diameter, enabling a user to actively and firmly grasp the upper portion of the grip 106, wherein the user's fingers are able to extend beneath the grip 106 upper portion. The lid 104 may include a seal (e.g., a rubber gasket) disposed annularly around the lid 104, preventing the contents of the body 102 from exiting the body 102 though any space manifested between the lid 104 and the body 102. As a non-limiting example, the seal may be composed of silicone or other suitable materials.

The lid rim 144 may be a flat annular member surrounding the top circumference of the lid 104. In an embodiment, the lid rim 144 may be configured to create a parallel and ‘continuous’ surface with the brim 126 when the lid 104 is inserted into the main aperture 130. The lid well 146 may taper from the lid rim 144 to the base of the grip 106. In one embodiment, as shown in FIG. 8, the bottom portion of the lid well 146 may be substantially flat and the side portion of the lid well 146 may be substantially curved. Thus, the lid well 146 may include a flat and circular portion proximate to the grip 106. Such a flat and circular portion may provide an adequate surface for interfacing the grip 106 to the lid well 146. Further, such a flat and circular portion may provide improved heat dissipation preventing the user from burning their hand when interfacing with the grip 106. The geometry of the lid 104, the grip 106, and components thereof, facilitate a grip 106 wherein a user may place one or more fingers beneath the grip 106 and utilize upward force to extract the lid 104 from the body 102.

Referring to FIG. 9, the lid 104 may further include a lid neck 148, a divot 150, and/or a lid sub-body 152. The lid sub-body 152 may account for the majority of the mass and volume of the lid 104. The lid sub-body 152 may be disposed below the lid neck 148. Accordingly, the lid sub-body 152 may reside within the cavity 132 when the lid rim 144 interfaces with the brim 126. The lid neck 148 may be a portion of the lid 104 having a smaller circumference than that of the lid sub-body 152 and/or the lid rim 144. The lid neck 148, the lid rim 144, and the lid sub-body 152 may form a divot 150 immediately adjacent to the lid neck 144. In such an embodiment, the divot 150 may be an indent in the lid 104 sized to accept one or more gaskets (not shown). The lid 104 may be composed of two pieces: a top piece and a bottom piece. The two pieces may be welded and/or otherwise coupled. Such a welding procedure may create an air gap between the surface exposed to hot temperatures and the surface the user may touch. Accordingly, the air gap acts as insulation that may prevent the lid 104 and/or grip 106 from overheating.

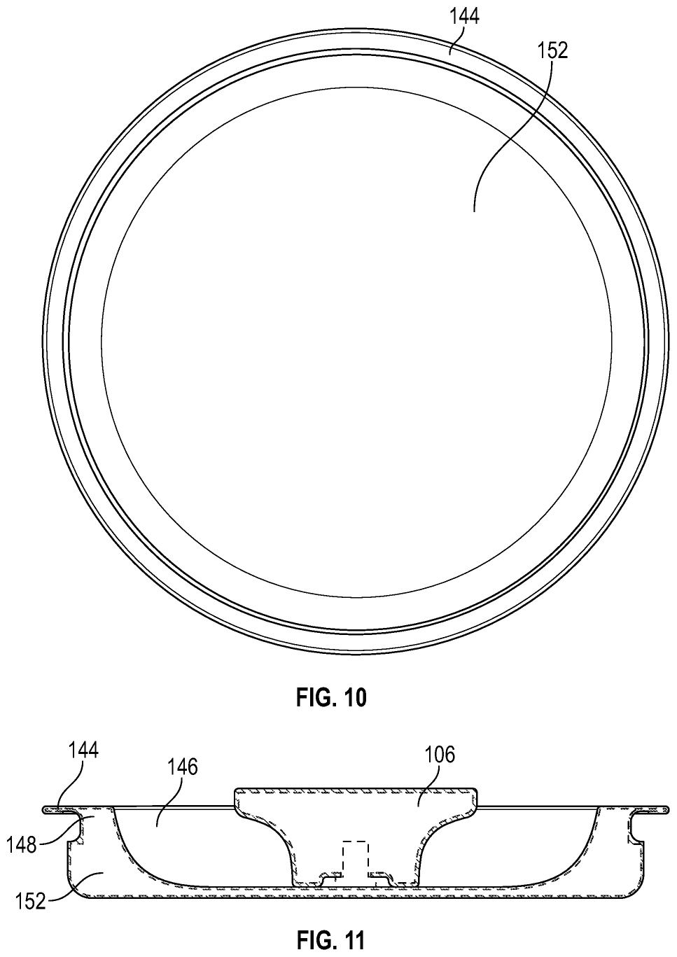

Referring to FIG. 10, the lid sub-body 152 may include a substantially flat bottom portion.

Referring to FIG. 11, the grip 106 may include a partially hollow component enabling a fastener to affix the grip 106 to the lid 104. The grip 106 may be mounted by a threaded part, wherein the threaded part may be welded to the lid 104. In an embodiment, the grip 106 may be composed of two sheets of metal and may be hollow. The partially hollow component of the grip 106, may allow for the user to interchange one or more grips with the threaded part. Said interchangeability, may allow for the user to customize the lid 104 with a grip 106 that better accommodates a user hand size or a user preference.

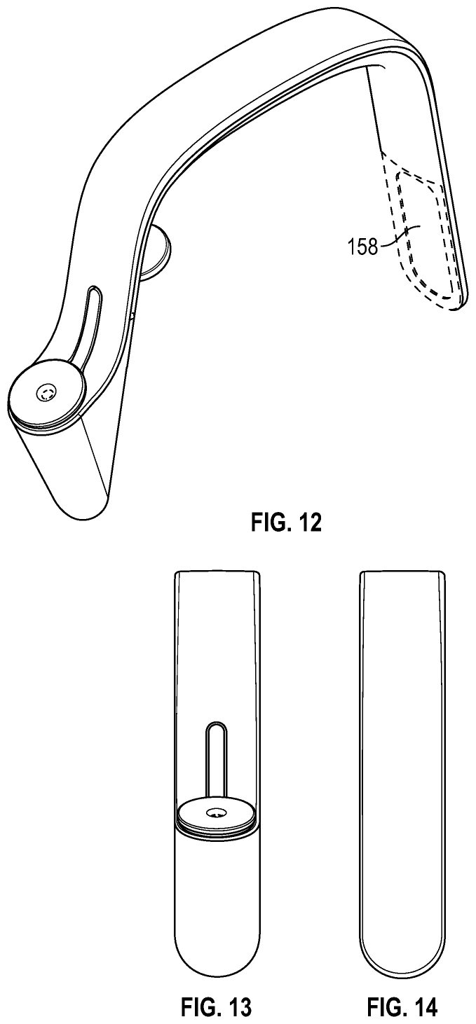

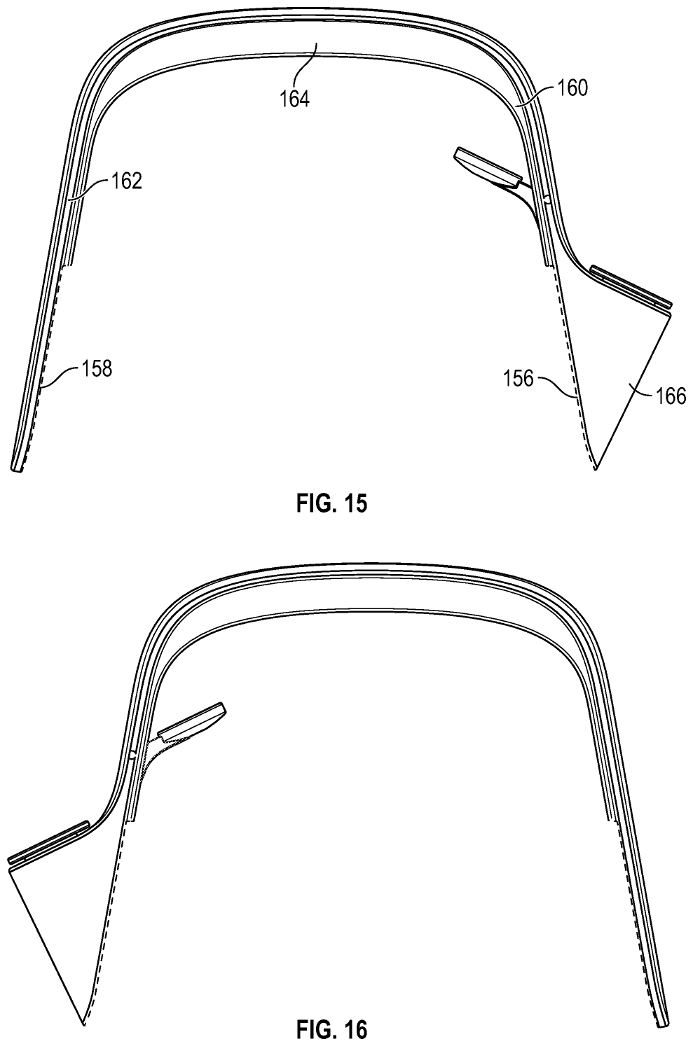

Referring to FIGS. 12-16, the handle 108 may include a proximal attachment point 156 and a distal attachment point 158. The proximal attachment point 156 may be disposed on the handle proximal end 110. Accordingly, the proximal attachment point 156 may be disposed on the handle inner surface 114 and may be sized to interface with the sidewall 124. In such an embodiment, the proximal attachment point 156 may be sized to eclipse the vent 134 without impeding the vent 134. The distal attachment point 158 may be configured to interface with the sidewall 124. The proximal attachment point 156 and/or the distal attachment point 158 may be recessed in the handle 108 such that a lip is formed on the handle inner surface 116 immediately above the proximal attachment point 156 and/or the distal attachment point 158. Such a lip may interface with the sidewall 124 and/or the brim 126 and may permit the handle 108 to reside closer to the body 102.

In an embodiment, the bottom portion and/or lower portion of the sidewall 124 may be thicker, for example, to complement the induction compatible sidewall bottom is thicker to add induction compatible baseplate plane 140. However, in another embodiment, the sidewall 124, and the kettle body 102 overall, may be of a uniform thickness. The handle 108 may further comprise a proximal post 160, a distal post 162, a bridge 164, and/or a spout 166. The proximal post 160 may be disposed on the handle proximal end 110 and may extend vertically from the spout 166. The distal post 162 may be disposed on the handle distal end 112. The bridge 164 may be disposed between the top portions of the proximal post 160 and the distal post 162. Accordingly, the bridge 164 may form a portion of the handle 108 conveniently gripped by a user. For example, the position and height of the bridge 164 may be adapted to permit utilization of the tab 122 via the user's thumb while the user's palm and fingers grip the bridge 164. In one embodiment, the bridge 164 may be of a greater thickness than the proximal post 160 and/or distal post 162. As a non-limiting example, the greater thickness of the bridge 164 may permit the user to firmly grasp the handle 108. The bridge 164 may be hollow and may be composed of sheet metal (i.e., 0.8 mm thick). In an embodiment, the hollow aspect of the bridge 164 may promote heat dissipation and/or may reduce the weight of the handle 108, thus, reducing the total weight of the kettle. The bridge 164 may be welded to the proximal post 160 and/or the distal post 162 to create a seamless appearance for the handle 108. Accordingly, heat transfer to the handle 108 and/or the bridge 164 may be reduced (for example, as compared to a full cast handle).

The spout 166 may be the portion of the handle 108 configured to accept the whistle 120 and direct gas and/or fluid from the cavity 132 to the environment. Thus, the spout 166 may include an internal hollow component. The spout 166 may be integral to the handle 108 and may be adapted to promote travel of gas and/or liquid from the cavity 132 to the environment. The handle 108, spout 166, and internal channel thereof, may be sized to maintain a sufficient pour and angle of the internal spout geometry. For example, the spout 166 may be angled to permit sufficient flow of water from and back into the kettle 100. Further, the spout 166 may be sized to maintain sufficient airflow for the whistle 120 to function. In an embodiment, the spout 166 angle is configured to reduce splatter of the contents of the kettle 100 while said kettle 100 is being poured. The spout 166 angle may facilitate pouring at a reasonable ergonomic angle without allowing contents to spill. Moreover, the angle and position of the spout 166 relative to the vent 134, as shown throughout FIGS. 1-16, enables a sufficient water fill line and promotes a kettle geometry adapted to boil water without undue leakage of contents. Additionally, the spout 166 angle may be adapted to permit integration of the spout 166 with the unibody handle 108 design. Accordingly, the angle of the spout 166 may allow the spout 166 to be seamlessly integrated with the handle 108. In such an embodiment, the handle 108 (including an integrated spout 166) may be formed as a unibody member, enabling streamlined manufacturing, assembly, and use.

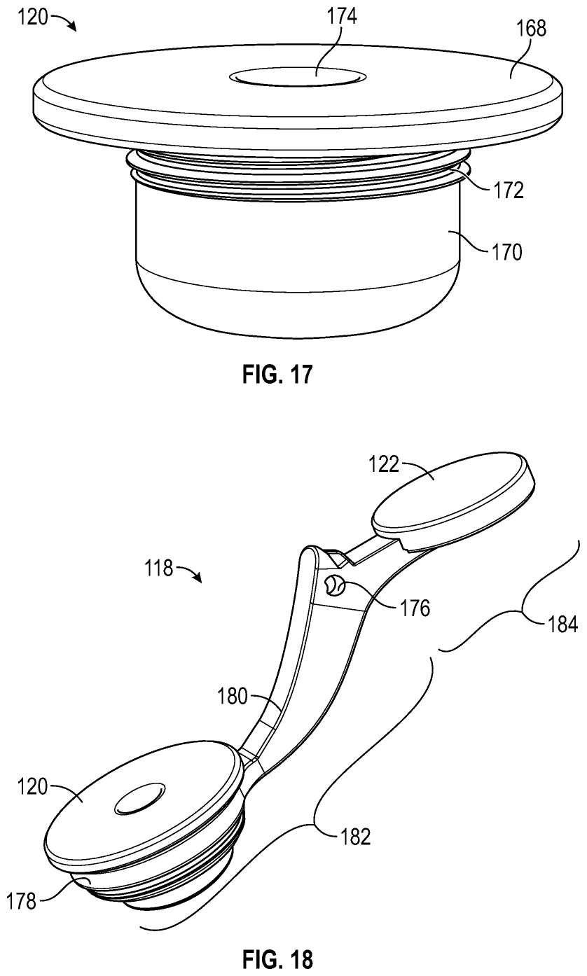

Referring to FIG. 17, the whistle 120 may include a whistle top portion 168, a whistle stem 170, a whistle thread 172, and/or a whistle bore 174. The whistle top portion 168 may be a disk-shaped member comprising the mouth of the whistle bore 174. The whistle bore 174 may be the hollow component of the whistle 120 adapted to induce the auditory tone. The whistle thread 172 may be disposed below the whistle top portion 168. Further, the whistle stem 170 may be disposed below the whistle thread 172. In an alternative embodiment, the whistle thread 172 may be disposed below the whistle stem 170. In another embodiment, the whistle thread 172 may be integral to the whistle stem 170, for example, wherein the whistle stem 170 is threaded for the entirety or the majority of the length of the whistle stem 170. The whistle stem 170 may be cylindrical with a curved bottom portion. The curved bottom portion may be sized and shaped to promote easy placement of the whistle 120 within the lever 118. In an embodiment where the whistle 120 attaches by a thread 172, a second thread may be disposed on the lever 118. As a non-limiting example, the whistle 120 may require roughly a single rotation to enable securement and/or removal of the whistle 120. In an embodiment, the whistle 120 interchangeably engages with the lever 118.

The whistle bore 174 diameter and/or length may be modified to alter the pitch, volume, and/or other audio characteristics of the resulting whistle. As a non-limiting example, there is a relationship between the bottom opening diameter of the bore 174 and the top opening diameter of the bore 174 (defining input and output volume). Further, the audio characteristics of the whistle 120 may be based on the internal volume and shape of the body 102 (for example, inducing how much turbulence is created inside of the kettle 100). Accordingly, by adjusting these metrics and others, different pitches and volumes may be curated. In an alternate embodiment, the kettle 100 may include a multitude of whistles, wherein the whistles vary in whistle bore diameter and/or length to alter the pitch, volume, and/or other audio characteristics of the resulting whistles. In the aforementioned embodiment, the user may interchange the multitude of whistles within the lever 118 to achieve a desired pitch, volume, and/or other audio characteristic.

Referring to FIG. 18, the lever 118 may further include a lever pivot hole 176 and a receiver aperture 178. The lever pivot hole 176 may align with the indexing hole 142 when the lever 118 is inserted into the gap 136. Thus, a pin or another suitable fastener may be placed within the lever pivot hole 176 and the indexing hole 142 to rotatably fix the lever 118 within the handle 108. The receiver aperture 178 may be an annular portion of the lever 118 sized to accept the whistle 120. As a non-limiting example, the receiver aperture 178 may include threads or another component complementary to that of the whistle 120 such that the receiver aperture 178 may receive and reversibly attach to the whistle 120. The lever 118 may include a link 180 connecting the tab 122 with the receiver aperture 178. Accordingly, the link 180 may translate downward movement of the tab 122 to upward movement of the receiver aperture 178 via pivoting about the lever pivot hole 176. Moreover, the link 180 may translate upward movement of the tab 122 to downward movement of the receiver aperture 178 via pivoting about the lever pivot hole 176. The lever 118 may include a lever proximal end 182 and a lever distal end 184. The lever proximal end 182 may include the portion of the lever 118 disposed between, and including, the receiver aperture 178 and the lever pivot hole 176. Conversely, the lever distal end 184 may include the portion of the lever 118 disposed between, and including, the lever pivot hole 176 and the tab 122. The placement of the lever pivot hole 176 may allow rotational movement of the lever 118 without creating undue interference. Further, the placement of the lever pivot hole 176 may maintain the desired angle and position to the installed spring to allow for actuation of the lever 118. In an embodiment, the non-circular shape of the pivot hole 176 defines the start and end point of rotation for the lever 118 (as described above).

The proximal lever end 182 may be lengthier than the distal lever end 184. Further, the proximal lever end 182 may include a downward curvature. Accordingly, actuation of the tab 122 and the consequential movement thereof may induce amplified movement in the receiver aperture 178.

The receiver aperture 178 may be configured to accept and reversibly affix the whistle 120 to the receiver aperture 178. As a non-limiting example, the receiver aperture 178 may include accepting threads complementary to the whistle thread 172. However, in alternate embodiments, the receiver aperture 178 may be affixed via any suitable means. In one embodiment, the whistle thread 172 may be replaced with and/or supplemented with a gasket, a retainer, or other means of creating a seal with the receiver aperture 178. In one embodiment, one or more gaskets may be disposed beneath the whistle top portion 168 and/or above or around the whistle stem 170. In such an embodiment, the one or more gaskets may be sized slightly larger than the receiver aperture 178 such that the whistle 120 may be firmly held within receiver aperture 178.

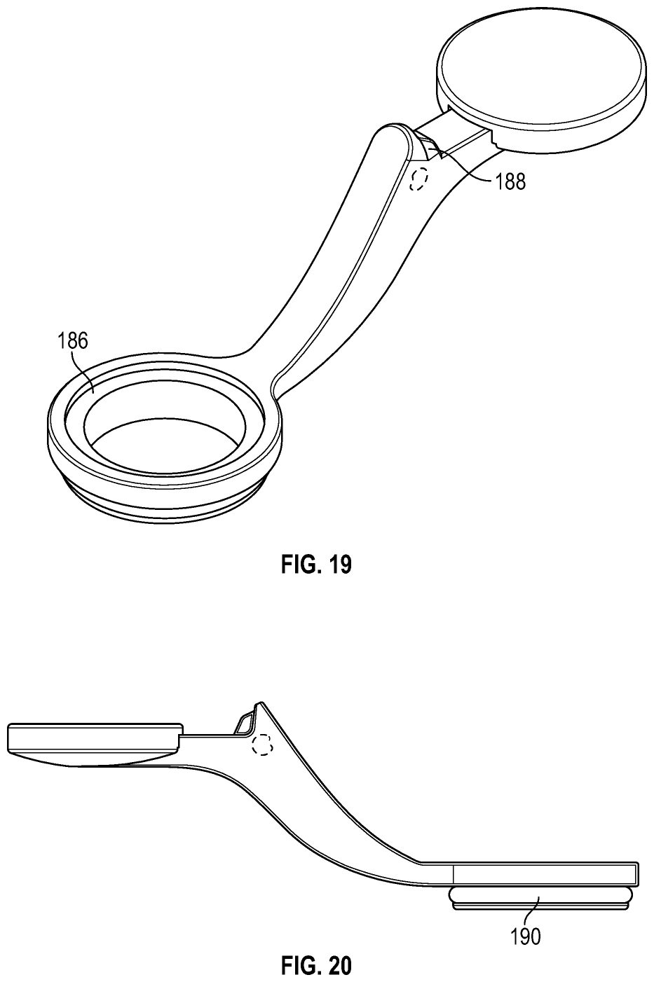

Referring to FIGS. 19-20, the receiver aperture 178 may include a ledge 186 disposed concentrically within the receiver aperture 178. The ledge 186 may be sized to accept the whistle thread 172 or another component of the whistle 120. Thus, the ledge 186 may be configured to interface with the whistle 120 such that the whistle 120 may be reversibly affixed to the receiver aperture 178. Further, the ledge 186 may be sized to prevent the whistle top portion 168 from entering past the receiver aperture 178.

In an embodiment, the lever 118 includes a nodule 188 disposed on the link 180. The nodule 188 may be a three-dimensional member extending from the link 180. In one embodiment, the nodule 188 may be configured to prevent over-extension and/or provide limitations on the movement of the lever 118 after tab 122 actuation. Thus, the nodule 188 may abut a portion of the gap 136 and/or handle 108 when the whistle 120 is in the raised position, preventing the whistle 120 from reaching an over-extended height. This nodule 188 may be configured to hold a spring, wherein said spring is configured to impart forces between the lever 118 and the handle 108. Further, the nodule 188 may be asymmetrical, allowing installation of the spring by hand. In one embodiment, after installation, the majority of the spring is hidden inside the handle 108. Alternatively, the spring can be removed if said part fails.

In an embodiment, the lever 118 remains in the open position after actuation, wherein an upward force may be applied to the tab 122 to return the lever 118 to the seated position. As a non-limiting example, if a user did not want the whistle 120 to engage during boiling, the user may simply press the lever 118 into the open position, where the lever 118 will remain uncoupled from the spout 166. As another non-limiting example, in an embodiment where the lever 118 remains in the open position after actuation, a user may more easily pour the contents from the spout 166, for example, not requiring the user to both hold the handle 108 and simultaneously engage the lever 118.

A spout gasket 190 may be disposed on the central and/or bottom portion of the receiver aperture 178 such that the spout gasket 190 induces a seal with the spout 166 in the seated position. The spout gasket 190 may be adapted to prevent steam and/or air from escaping through the gaps between the lever 118 and spout 166 geometry. Further, the resulting seal may allow the whistle 120 to function properly when the lever 118 is in a closed position.

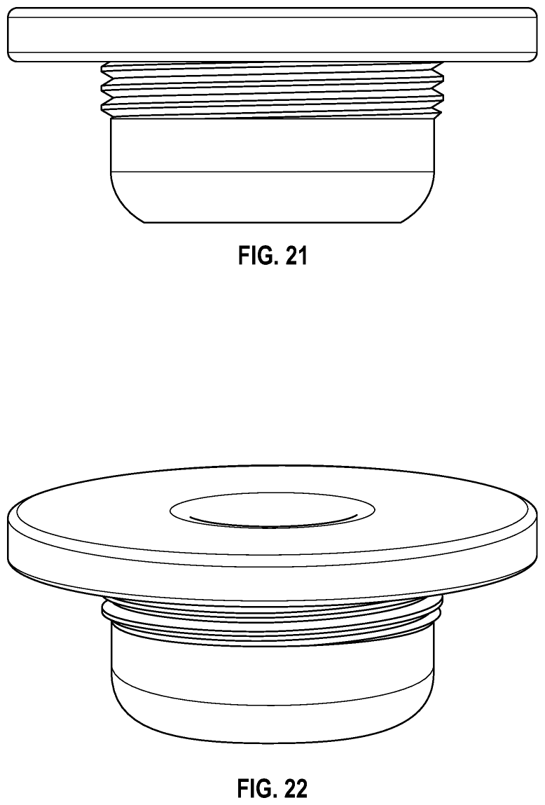

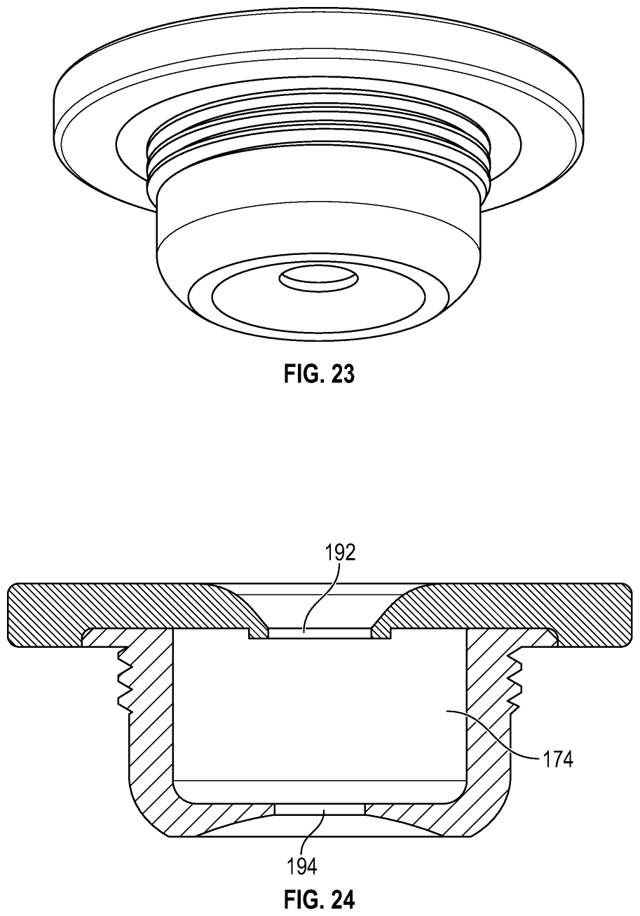

Referring to FIGS. 21-24, the whistle 120 may include a top whistle opening 192 and a bottom whistle opening 194, wherein the top whistle opening 192 is adapted for exposure to the environment and the bottom whistle opening 194 is adapted for exposure to the spout 166. In one embodiment, the top whistle opening 192 may be of a greater diameter than that of the bottom whistle opening 194, or vice versa. However, in various embodiments the top whistle opening 192 and the bottom whistle opening 194 may be of any suitable dimensions. Further, the top whistle opening 192 may be recessed within the whistle top portion 168 and the bottom whistle opening 194 may be recessed within the bottom portion of the whistle 120. In an embodiment, the removable whistle 120 enables simplistic removal and provides a means for cleaning the whistle 120 and/or surround components of the kettle. Accordingly, the whistle 120 geometry as explained herein provides a sanitary improvement over conventional kettles.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A kettle comprising:
a body comprising a vent;
a lid reversibly connectable to the body; and
a unibody handle comprising:
a distal end and a proximal end, each of the distal end and the proximal end disposed on the body,
a lever disposed at least partially within the unibody handle, the lever comprising:
at least one interchangeable whistle disposed on a lever proximal end,
wherein the at least one interchangeable whistle reversibly attaches to the lever,
wherein the at least one interchangeable whistle is configured to be in at least one of a seated position and a raised position,
a tab disposed on a lever distal end,
wherein actuation of the tab causes the at least one interchangeable whistle to move from at least one of the seated position to the raised position, and
a spout disposed on the proximal end,
wherein the spout entirely eclipses the vent.

2. The kettle of claim 1, wherein the body further comprises:
a baseplate;
a brim; and
a sidewall, having a sidewall top portion and a sidewall bottom portion, disposed between the brim and the baseplate.

3. The kettle of claim 2, wherein the sidewall bottom portion is of a greater thickness than the sidewall top portion, such that the difference in thickness induces convection heating of a kettle contents.

4. The kettle of claim 2, wherein the baseplate further comprises:
a bevel surrounding a perimeter of the baseplate.

5. The kettle of claim 1, further comprising:
a lid;
a mount disposed atop the lid; and
a partially hollow grip attached to the mount.

6. The kettle of claim 5, wherein the mount and the partially hollow grip are configured to threadably attach.

7. The kettle of claim 1, wherein the lid is comprised of a lid top piece and a lid bottom piece, wherein the lid top piece and the lid bottom piece form an air gap configured to reduce heat transfer between the lid bottom piece and the lid top piece.

8. The kettle of claim 1, wherein the distal end and the proximal end are partially recessed within the body.

9. The kettle of claim 1, further comprising a bridge disposed between the distal end and the proximal end.

10. The kettle of claim 1, further comprising a gap disposed at the proximal end, wherein the lever is configured to be received by the gap.

11. The kettle of claim 10, further comprising an indexing hole disposed at the proximal end.

12. The kettle of claim 11, further comprising a lever pivot hole disposed upon the lever.

13. The kettle of claim 12, further comprising a fastening pin configured to be inserted through both the indexing hole and the lever pivot hole to attach the lever to the unibody handle.

14. The kettle of claim 11, wherein the lever comprises a link traversing the lever pivot hole and a receiver aperture disposed at the lever proximal end, wherein the receiver aperture is configured to accept the at least one interchangeable whistle, and wherein, in the seated position, the link sits flush with the unibody handle.

15. The kettle of claim 1, further comprising a receiver aperture disposed at the lever proximal end, wherein the receiver aperture is configured to accept the at least one interchangeable whistle.

16. The kettle of claim 15, wherein the receiver aperture and the at least one interchangeable whistle threadably engage.

17. The kettle of claim 1, wherein the at least one interchangeable whistle further comprises a whistle bore, wherein the whistle bore is hollow and is adapted to induce an auditory tone.

18. The kettle of claim 17, wherein the at least one interchangeable whistle further comprises a whistle top opening, having a top opening diameter, and a whistle bottom opening, having a bottom opening diameter.

19. The kettle of claim 18, wherein the top opening diameter and the bottom opening diameter are not equal.
